(19) United States
(12) Patent Application Publication
(10) Pub. No.: US 2016/0292595 A1
(43) Pub. Date: Oct. 6, 2016

(54) SYSTEM AND METHOD FOR MUSIC DISCOVERY, LIVE EVENT NOTIFICATION, AND FAN ENGAGEMENT

(71) Applicant: Caktus Music, Inc., West Lafayette, IN (US)

(72) Inventors: Keith Alan Williams, West Lafayette, IN (US); Dane Gerard Regnier, Indianapolis, IN (US); Chase Acton, Carmel, IN (US)

(21) Appl. No.: 15/087,346

(22) Filed: Mar. 31, 2016

Related U.S. Application Data
(60) Provisional application No. 62/141,041, filed on Mar. 31, 2015.

(51) Int. Cl. G06Q 10/02; H04L 12/58; G06F 17/30

(52) U.S. Cl. CPC G06Q 10/02; G06F 17/30241; G06F 17/30752; G06F 17/30061; H04L 51/24

(57) ABSTRACT

A system and method for providing live event notification for fan engagement, including a user database for accessing a plurality of user preferences, a play database for accessing a plurality user's music habits, a third party database for accessing other media platforms, an activity database for accessing a plurality of activities that a user may attend, an analytics engine operably configured to generate a user profile, a search engine operably configured to select at least one musical event from the activity database, and a notification system operably configured to present the at least one musical event.

### PRIORITY

The present application claims benefit from U.S. Provisional Patent Application No. 62/141,041, filed on Mar. 31, 2015, which is incorporated in its entirety by reference herein.

### BACKGROUND

Music is an integral part of people's lives. Many people define themselves based on the music that they enjoy. The sheer amount of music available to listen to at any given time makes it difficult to find music that fits a particular person's taste.

The economics of the music industry have also evolved. While single and album sales are dropping, sales of concert tickets are rising. Even so, only the top artists are selling out concerts, while all other artists are trying to find ways to get noticed by consumers. The peer-to-peer music sharing era stifled the tradition manner in which music artists were discovered. Today, these same artists are struggling to upload a music song or video that goes viral through social media.

From the social standpoint, public behavior about music is also changing. Consumers of music are part of a convenience culture, where people are more inclined to listen to music that is available quickly and without cost. For example, consumers listen to music and make music purchases via mobile players and listen to music that streams for free. The conversation about what music to listen to and purchase is moving more and more towards social media outlets than inside the record store.

Lastly, technological improvements have allowed music to be purveyed in manners other than mere physical media, with digital storage and streaming now becoming the norm. Technological improvements have also upended the traditional music industry hierarchy and created self-promotion and management models that offer opportunities for musicians to build their own record label or be discovered in other channels (e.g. YouTube, Last.fm).

Despite the modernization of the music industry, there is still a need to drive exposure and fan-base growth for most artists. Independent artists face an uphill battle for exposure without radio play, and most of new music discovery happens through AM/FM radio play or word-of-mouth referral.

Compounding this issue is the fact that fan engagement with artists is difficult. Although self-identified fans are proven to spend more money on music related purchases, artists have difficulty finding a foothold when it comes to engaging fans outside of the traditional channels (e.g. radio play).

One way to facilitate artist profitability and fan and artist engagement is to capitalize on the combination of artist exposure, virality of the artist's music, and music related purchases. For example, consumers of music are more vested in the success of artists whose music they are familiar with. Artists have easier exposure to consumers when their music is more readily available. For artists, fan engagement means having a communication platform that can leverage social media and create influences that persuade consumers to try the artist's music and, hopefully, make a song purchase or attend a show. Lastly, the economics of the relationship can be strengthened by music related sales that are driven by metrics and analytics that focus on the consumer's interests, preferences, and other factors related to fan engagement.

Accordingly, there exists a need for a system and method for music discovery, live event notification, and fan engagement. Moreover, there exists a need for a system and method that can efficiently, reliably, and quickly boot artists' fan-bases and fan engagement, promote the artists' virality and exposure, and consequently increase music revenue.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 displays a schematic drawing of a system for providing support for music discovery, similar music identification, and fan engagement according to at least one embodiment of the present disclosure.

FIG. 2 displays a combination flowchart of a method and components in an architecture of a system providing support for music discovery, similar music identification, and fan engagement according to at least one embodiment of the present disclosure.

FIG. 3 displays a flowchart displaying steps in a method for providing support for music discovery, similar music identification, and fan engagement according to at least one embodiment of the present disclosure.

FIG. 4 displays a flowchart displaying steps in a method for providing support for music discovery, similar music identification, and for fan engagement according to at least one embodiment of the present disclosure.

FIG. 5 displays a flowchart displaying steps in a method for providing support for music discovery, similar music identification, and fan engagement according to at least one embodiment of the present disclosure.

FIG. 6 displays a screenshot of a mobile application generated through execution of the methods described herein and/or use of the systems described herein.

FIG. 7 displays a screenshot of a mobile application generated through execution of the methods described herein and/or use of the systems described herein.

FIG. 8 displays a screenshot of a mobile application generated through execution of the methods described herein and/or use of the systems described herein.

FIG. 9 displays a screenshot of a mobile application generated through execution of the methods described herein and/or use of the systems described herein.

FIG. 10 displays a screenshot of a mobile application generated through execution of the methods described herein and/or use of the systems described herein.

### DETAILED DISCLOSURE

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This detailed description is presented in terms of programs, data structures or procedures executed on a computer or network of computers. The software programs implemented by the system may be written in any programming language—interpreted, compiled, or otherwise. These languages may include, but are not limited to, PHP, ASP.net, HTML, HTML5, Ruby, Perl, Java, Python, C++, C#, JavaScript, and/or the Go programming language. It should be appreciated, of course, that one of skill in the art will appreciate that other languages may be used instead, or in combination with the foregoing and that web and/or mobile application frameworks may also be used, such as, for example, Ruby on Rails, Node.js, Zend, Symfony, Revel, Django, Struts, Spring, Play, Jo, Twitter Bootstrap and others. It should further be appreciated that the systems and methods disclosed herein may be embodied in software-as-a-service available over a computer network, such as, for example, the Internet. Further, the present disclosure may enable web services, application programming interfaces and/or service-oriented architecture through one or more application programming interfaces or otherwise.

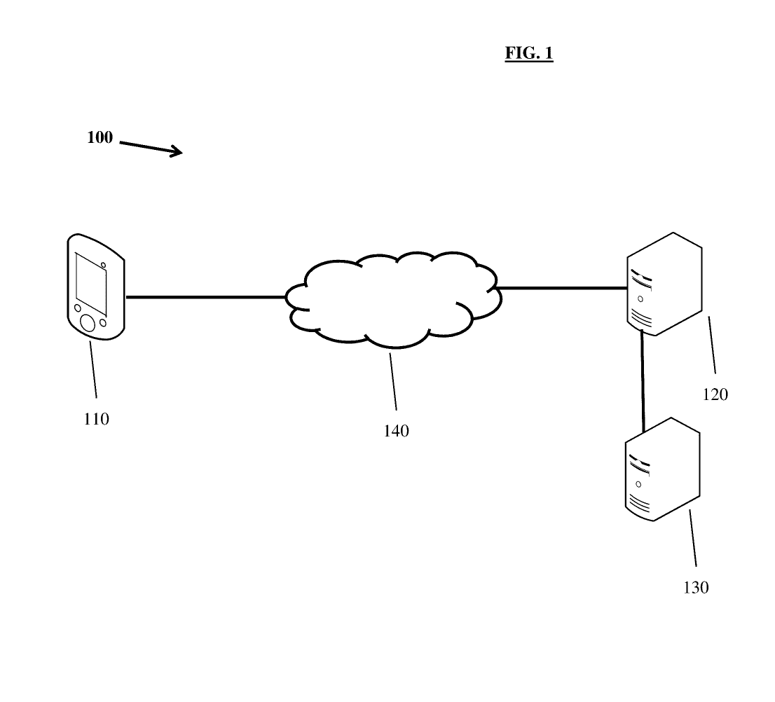

Referring now to FIG. 1, there is shown a schematic drawing of a system 100 for providing live event notification for fan engagement. In at least one embodiment of present disclosure, the system 100 comprises client device 110, server 120, database 130, and computer network 140.

The client device 110 may be configured to transmit information to and generally interact with a web service and/or application programming interface infrastructure housed on server 120 over computer network 140. The client device 110 may include a web browser; mobile application, socket or tunnel, or other network connected software such that communication with the web services infrastructure on server 120 is possible over the computer network 140.

The client device 110 includes one or more computers, smartphones, tablets, wearable technology, computing devices, or systems of a type well known in the art, such as a mainframe computer, workstation, personal computer, laptop computer, hand-held computer, cellular telephone, MP3 player, or personal digital assistant. The client device 110 comprises such software, hardware, and componentry as would occur to one of skill in the art, such as, for example, one or more microprocessors, memory systems, input/output devices, device controllers, and the like. The client device 110 also comprises one or more data entry means (not shown in FIG. 1) operable by users of the client device 110 for data entry, such as, for example, voice or audio control, a pointing device (such as a mouse), keyboard, touchscreen, microphone, voice recognition, and/or other data entry means known in the art. The client device 110 also comprises a display means (not shown in FIG. 1) which may comprise various types of known displays such as liquid crystal diode displays, light emitting diode display, and the like upon which information may be display in a manner perceptible to the user. It will be appreciated that client device 110 may further comprise a Global Positioning System (GPS) transceiver and such software, hardware, and componentry as would occur to one of skill in the art, to operably perform the functions allocated to the client device 110 in accordance with the present disclosure.

The database 130 is configured to store information generated by the system 100 and/or retrieved from one or more information sources. In at least on embodiment of the present disclosure, database 130 can be “associated with” server 120 where, as shown in the embodiment in FIG. 1, database 130 resides on server 120. Database 130 can also be “associated with” server 120 where database 130 resides on a server or computing device remote from server 120, provided that the remote server or computing device is capable of bi-directional data transfer with server 120, such as, for example, in Amazon AWS, Rackspace, or other virtual infrastructure, or any business network. In at least one embodiment of the present disclosure, the remote server or computing device upon which database 130 resides is electronically connected to server 120 such that the remote server or computing device is capable of continuous bi-directional data transfer with server 120.

For purposes of clarity, database 130 is shown in FIG. 1, and referred to herein as a single database. It will be appreciated by those of ordinary skill in the art that database 130 may comprise a plurality of databases connected by software systems of a type well known in the art, which collectively are operable to perform the functions delegated to database 130 according to the present disclosure. Database 130 may also be part of distributed data architecture, such as, for example, a Hadoop architecture, for big data services. Database 130 may comprise relational database architecture, noSQL, OLAP, or other database architecture of a type known in the database art. Database 130 may comprise one of many well-known database management systems, such as, for example, MICROSOFT's SQL Server, MICROSOFT's ACCESS, MongoDB, Redis. Hadoop, or IBM's DB2 database management systems, or the database management systems available from ORACLE or SYBASE. Database 130 retrievably stores information that is communicated to database 130 from client device 110 or server 120.

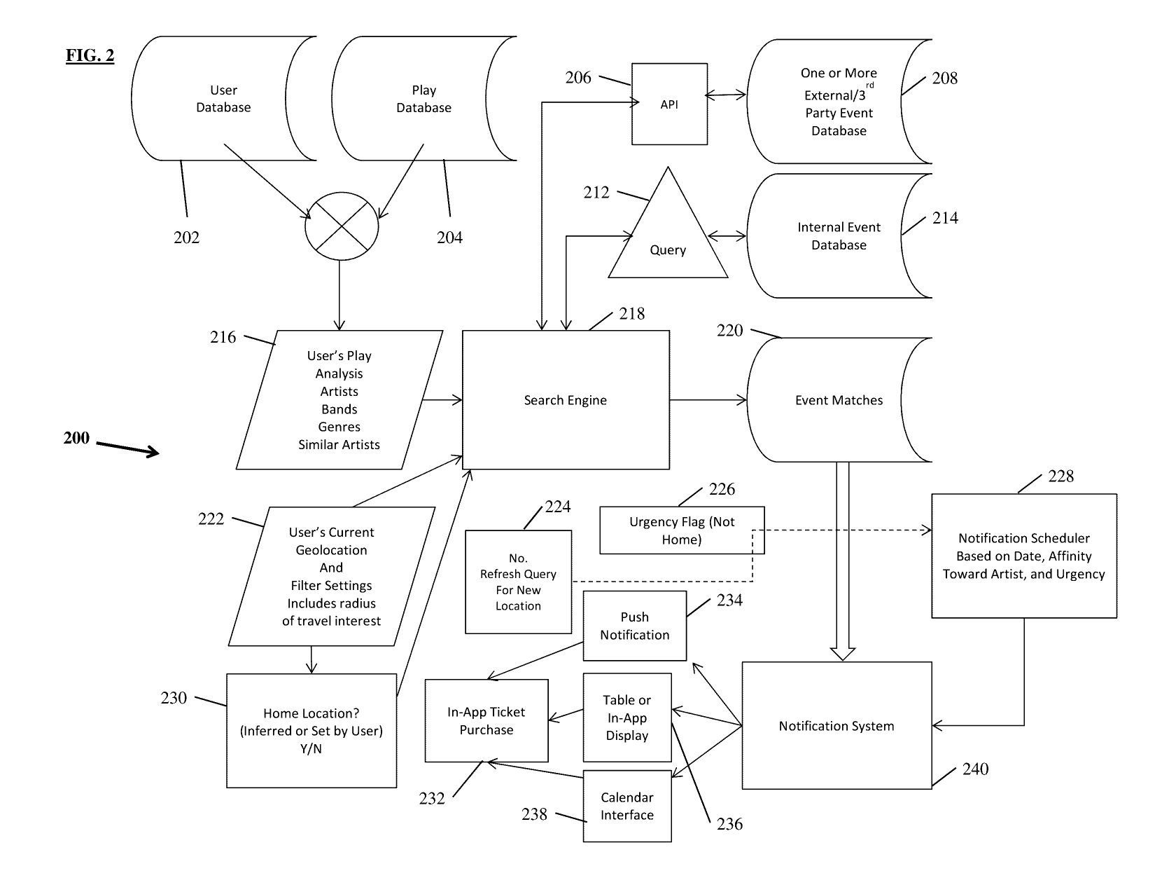

FIG. 2 illustrates components and a flowchart associated with a system 200 for fan engagement according to at least one embodiment of the present disclosure. As shown in FIG. 2, the system 200 includes a user database 202, a play database 204, a third party database 208, a user analytics engine 216, a search engine 218, and a notification system 240.

In at least one embodiment of the present disclosure, the user database 202 is configured to maintain information about a user. User database 202 includes information about a user such as, for example, demographic information, music preferences, social media profile information, travel habits, travel schedules, travel locations, and other information as would occur to one of skill in the art, to operably perform the functions allocated to the user database 202 in accordance with the present disclosure. It will be appreciated that user database 202 further comprises social media activity of the user such as, for example, music reviews, followers, key opinion influences, topic relevance, topic's unique followers, music ratings, social media posts, social media engagements, social media trends, and social media influences. It will be further appreciated that user database 202 comprises information about a user's attitude, opinion, belief, thought, judgment or emotion as it relates to a topic, like music.

In at least one embodiment of the present disclosure, the play database 204 comprises information about a user's music choices, such as, for example, the name of an artist, album information, playlist information, track information, and play statistics. It will be appreciated that play statistics includes information such as, for example, the number of times a song was played, time of day when the song was played, and the last time the song was played.

In at least one embodiment of the present disclosure, one or more third party databases 208 are third party databases generally available over the Internet, such as, for example, Facebook, Twitter, Spotify, Pandora media, Apple iTunes, and SoundCloud. It will be appreciated that third party database 208 may be accessed via third party application programming interface (API) 206.

In at least one embodiment of the present disclosure, the user analytics engine 216 is operably configured to generate a user profile analysis about a user's music playing habits. Analytics about a user's music playing habits includes information such as, for example, identifying the genre of the type of song the user prefers, identifying similarities in the songs that the user listens to, and determining a user's behaviors with the types of songs being played.

In at least one embodiment of the present disclosure, the search engine 218 is operably configured to use the user profile from the user analytics engine 216, and access third party database 208 and internal event database 214. The search engine 218 is further configured to place results into event match database 220.

In at least one embodiment of the present disclosure, the notification scheduler 228 is operably configured to generate event alerts to notification system 240. Notification system 240 is operably configured to generate notifications such as, for example, a push notification 234, or an in-app display 236, or on a calendar interface 238.

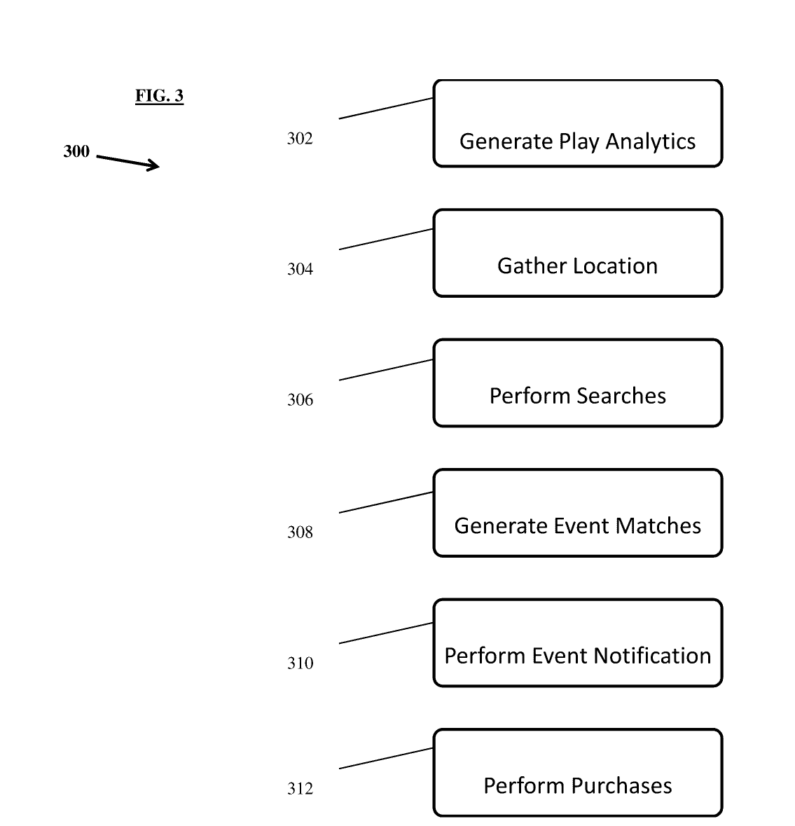

FIG. 3 illustrates a method for providing live event notification for fan engagement, generally indicated at 300. In at least one embodiment of the present disclosure, the system 300 comprises step 302 of generating play analytics, step 304 of gathering location; step 306 of performing searches, step 308 of generating event matches, step 310 of performing event notification, step 312 of performing purchases.

In at least one embodiment of the present disclosure, step 302 includes generating the user profile. In step 302, the user analytics engine 216 is configured to use information from user database 202 and play database 204 to generate analytical information about a user. In at least one embodiment of the present disclosure, step 302 gathers demographic information about the user, social media information about the user, detects a play history for a first artist and a first song the user listens to, gathers a user's music habits about a song, and collects social media information about the user, the first artist, and the first song. Step 302 further identifies a user's preference (or the likelihood towards a certain preference) for certain types of music, music artist, music genre. It will be appreciated that the demographic information such as, for example, demographics, geographic location, behavior, preferences, interests, and the like. It will be appreciated that step 302 identifies music to which the identified user has the greatest reaction to. For example, a type of reaction such as, for example, positive or negative is also identified at step 302.

It will be appreciated that gathering the user's music habits further comprises identifying a type of song the user prefers, identifying a similarity in the songs the user listens to, and identifying the user's activity when listening to a song. For example, a user may prefer high-energy music when working out, but prefers calming music when relaxing. It will be appreciated that the user's music habits are reflective of the time, place, and mood during which the user listens to a particular song or artist.

It will further be appreciated that social media information is selected from a group comprising song reviews, followers, key opinion influences, topic relevance, topic's unique followers, song ratings, social media posts, social media engagements, social media trends, and social media influences. For example, a user's social media post advocating a certain song or certain artist is indicative that the user will have a positive reaction to the artist or the song. It will be appreciated that the user's social media activity is probative of the user's music preferences to show how engaged (or enthusiastic) the identified user would be with a particular music artist, music track, or music genre.

In at least one embodiment of the present disclosure, step 304 queries the user database 202 to gather location information relating to the user such as, for example, scheduled events, calendar entries, activities, venues, locations, facilities, and the like. Step 304 generates a location chart that contains physical locations of where the user is, or is expected to be at a given point in time. In at least one embodiment of the present disclosure, a location chart can display the user's location in an instant by obtaining the user's physical location from user device 110. It will be appreciated that step 304 also creates a location chart for a user based on where the user will be at a future point in time. In one example, if the user's calendar entry demonstrates that a user will be in a certain location based on a calendared commitment, step 304 identifies the expected location on the location chart.

In at least one embodiment of the present disclosure, step 306 performs event searches using search engine 218. It will be appreciated that search engine 218 uses the location chart from step 304, as one search parameter, along with event information from third party database 208 and internal event database 214. It will be appreciated that the system 100 may receive activity information from multiple sources such as music promoters, local news outlets, classified listings, advertisements, social media feeds, enterprise sources, other search engines, reviews, and other recommendation systems.

In step 306, the search engine 218 identifies acceptable event matches based on a variety of additional information such as, for example, a history of previously attended events, user feedback about those previously attended events, musical interests, future musical events, profiles of particular artist(s), and the play analytics identified in step 302. In at least one embodiment of the present disclosure, the search engine 218 identifies musical activities that the user may wish to participate in, like concerts, and social and community events. It will be appreciated that search engine 218 may also identify promotional events and advertising that the user can participate in and which offers incentives such as, for example, discounted tickets, merchandize, and other perks. In one example, if an artist is performing at a certain venue, and the user will be in the vicinity of the venue around when the concert is being held, the system 100 will identify the concert as a possible event for the user who has demonstrated an interest in the artist. The system 100 may also identify a promotional event, such as a ticket raffle that might be of interest to the user.

In at least one embodiment of the present disclosure, step 308 generates event matches, the event matches based at least in part on one or more constraints imposed by the user. After search results are identified in step 306, results are identified that the user is mostly likely interested in, and based on a plurality of factors, including any user specified constraints (e.g., date, timeframe, geographic location, weather) that are to be imposed on the musical activity.

In at least one embodiment of the present disclosure, step 308 presents the event matches identified in step 306, to a user device, such as, for example, through a mobile application. At least one example of a mobile application. It will be appreciated that event notification can be a push notification, an in-app display, or presented via a calendar interface.

In at least one embodiment of the present disclosure, step 310 performs purchases. After event notification in step 308, a user who wishes to make a purchase for the identified musical activity, is presented with pricing information that may include information such as, for example, the base price to purchase tickets to an event, or to make purchases of commerce, such as concert merchandise, and the like. It will be appreciated that such a purchase can be a monetary exchange, or a barter for value.

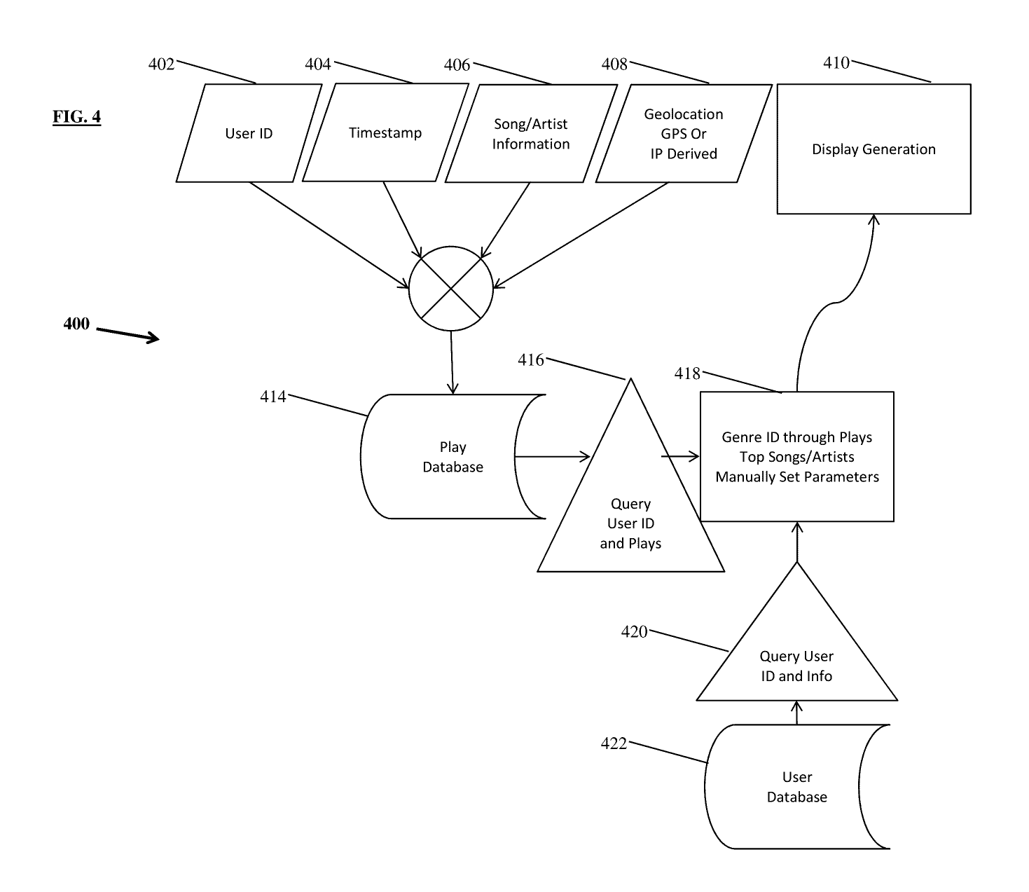

Referring now to FIG. 4, it is shown a flowchart 400 displaying how components of a system interact to identify socially relevant artists and songs according to at least one embodiment of the present disclosure.

A user playing music on a smartphone through a mobile application may desire to identify similar artists and songs to play next. When listening to a specific song, the user generates a user id 402, a timestamp 404, information associated with the song and artist that the user is listening 406, and a location of the accompanying user device 408. This information is entered into a play database 414 associated with the user record.

In at least one embodiment of the present disclosure, the play database 414 may contain user id 402, timestamp 404, song and artist information 406, and geolocation 408 for many different users over many different songs. For example, play database 414 may contain information associated with: 1) user A in Chicago playing an Avril Lavigne track at 2:15 pm on Mar. 29, 2016; 2) user B in Chicago playing a Taylor Swift track at 2:12 pm on Mar. 29, 2016; and user C in Indianapolis playing a Metallica track at 2:11 pm on Mar. 29, 2016. In this example, the play database 414 contains individual records for each user play.

A query 416 may then be performed to identify similar songs for the user to explore based off of information in the play database 414. Following the example further, in the event that user A desires to find a similar song to the Avril Lavigne track that he or she is playing, the play database 414 could be queried against other user plays 416. With data available for all users playing all songs at all times and in all locations, a query 416 on all information in the play database 414 to find a similar song for user A may be performed. The query 416 may consider various types of information, including whether other users in the play database 414 are friends or followers of user, the genre of the songs played, the geographic location of other song plays, and other information.

Each song and artist in the play database 414 is also analyzed against additional information 418 to better identify relevant tracks and plays. Additional information may include a genre ID associated with the artist and/or song, a listing of top songs and artists, or other manually set parameters. Information also may be pulled from a user database 422 with user information queries 420 to further filter the results.

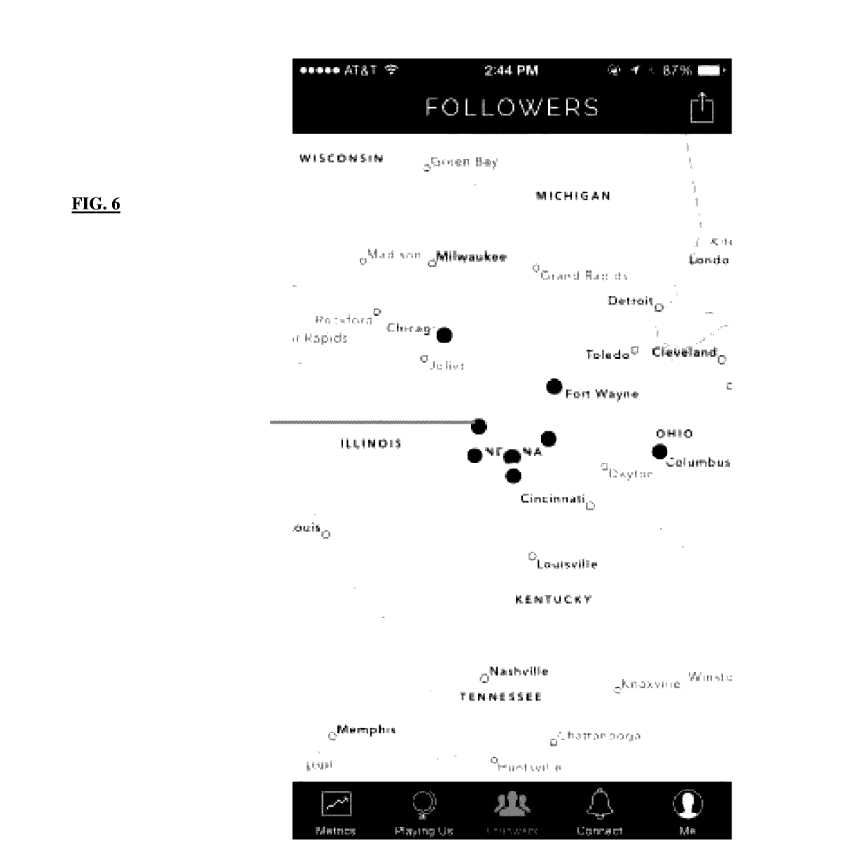

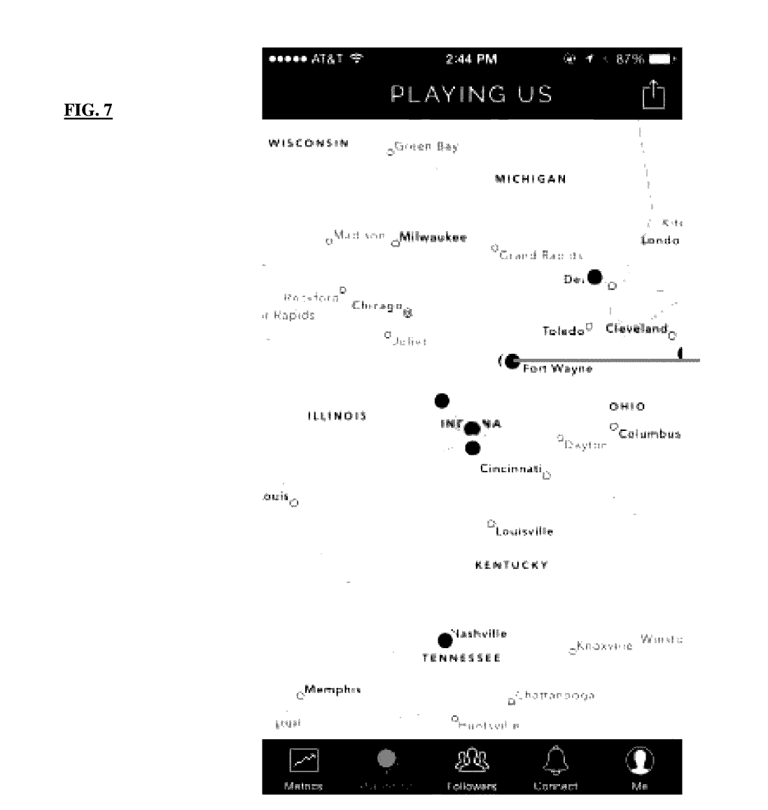

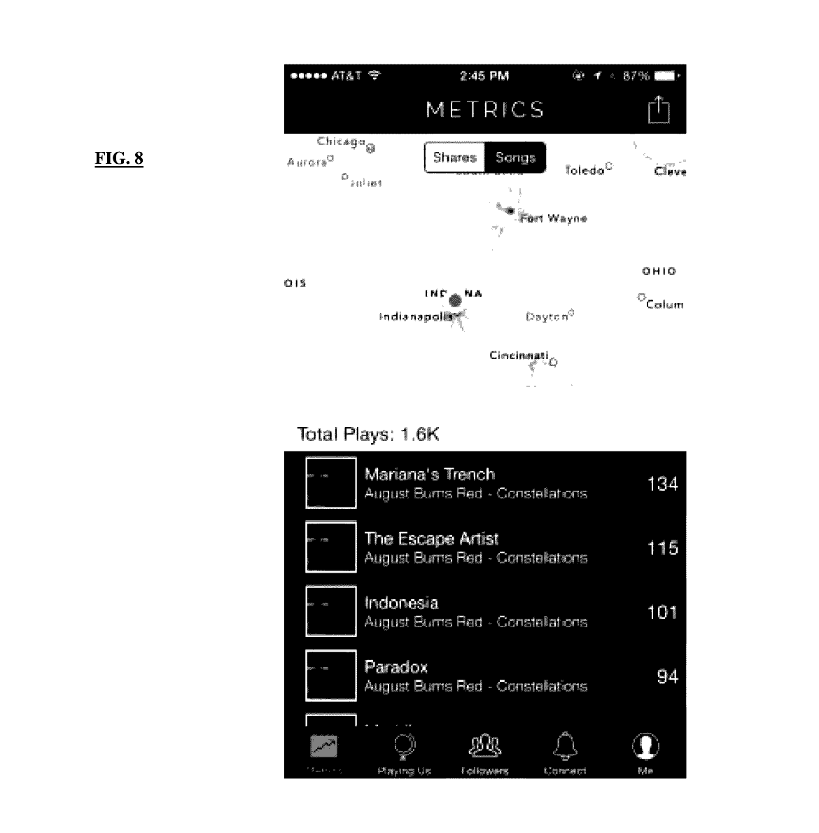

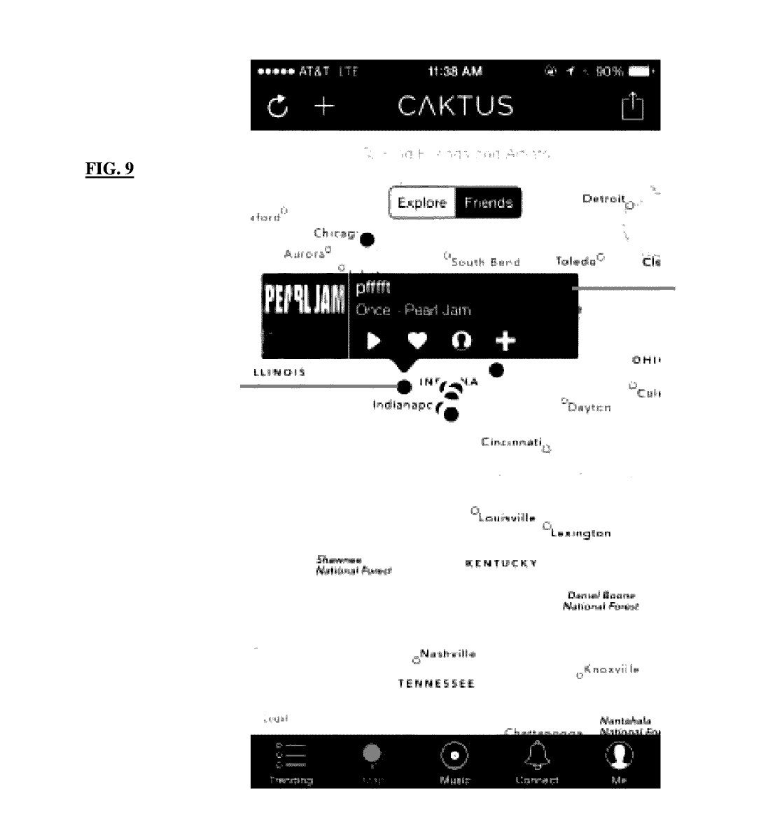

Upon identifying relevant plays in the play database 414 to show the user, these plays are displayed 410 in a graphical user interface for the user. The plays may be displayed 410 in a map format using the geolocation information associated with each play. The plays may also be displayed 410 based off of whether the user follows the user id associated with each play. Example screenshots showing maps of plays is displayed in FIGS. 6, 7, 9, and 10. As shown in FIGS. 8 and 9, when a user clicks on a displayed play listing, an option may be presented to the user to play, buy, or like that song or follow the particular user that played the song.

Individual metrics may also be obtained for each song. With the play database 414 including all information of all user plays, heat maps (e.g. the heat map shown in FIG. 8) may be generated to show activity associated with a specific song, artist, or genre.

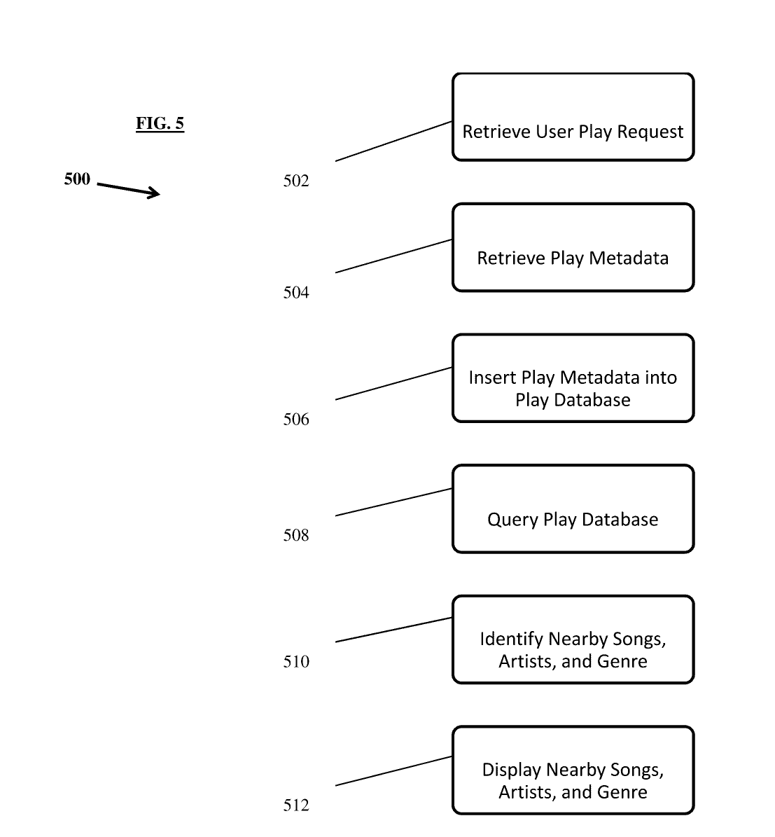

Referring now to FIG. 5, it is shown a method 500 to identify socially relevant artists and songs according to at least one embodiment of the present disclosure. As shown in FIG. 5, the method 500 includes retrieving a user play request in step 502, retrieving play metadata in step 504, inserting play metadata into a play database in step 506, querying the play database in step 508, identifying nearby songs, artists, and genres in step 510, and displaying nearby songs, artists, and genres in step 512.

In at least one embodiment of the present disclosure, the method 500 includes retrieving a user play request in step 502. In step 502, a user interacting with an application, such as, for example, a mobile application, requests a song to be played. In such an embodiment, the user may request that the song be played from a downloaded library of music or an online streaming music service.

In at least one embodiment of the present disclosure, the request to play the song includes metadata which is retrieved in step 504 by the application. In such an embodiment, the metadata may include a user id, name song, artist, timestamp of play, and a geolocation of the user. In one embodiment, the user id is associated with a social media account name, either directly on the social media platform or through open authentication utilities, like openId and oauth. Alternatively, the user may have a user id associated with the application directly.

In some embodiments, the song and artist information is obtained directly from the downloaded media being played. In other embodiments, the song and artist information may be retrieved from the streaming service in which the user play is requested, such as through an application programming interface. The geolocation of the user may be obtained by the application through a variety of ways, such as, for example, IP geolocation techniques, GPS technology within a smartphone at application run time, or otherwise.

In at least one embodiment of the present disclosure, the play metadata is inserted into a play database in step 506. It should be appreciated that the play database is discussed in reference to FIG. 4 herein. As discussed, the play database may contain play information for all user plays within the application.

The play database may be queried in step 508 by the application on behalf of the user. The query from the play database may be evaluated to identify nearby songs, artists, and genres to the user's geographic proximity in step 510. In some embodiments, the plays of nearby songs, artists, and genres are populated based on other users of the application that the user has chosen to follow. In some embodiments, all nearby plays of songs, artists, and genres available to the user may be identified.

In at least one embodiment of the present disclosure, plays of nearby songs, artists, and genre may be limited in step 510 to only those that are relevant to the perceived musical taste of the user. In such an embodiment, each song play associated with the user in the play database may have metadata associated with artist and genre. In step 510, the artist and genre information stored in the play database may be used to identify other plays of similar artists and genres nearby the user's geographic proximity.

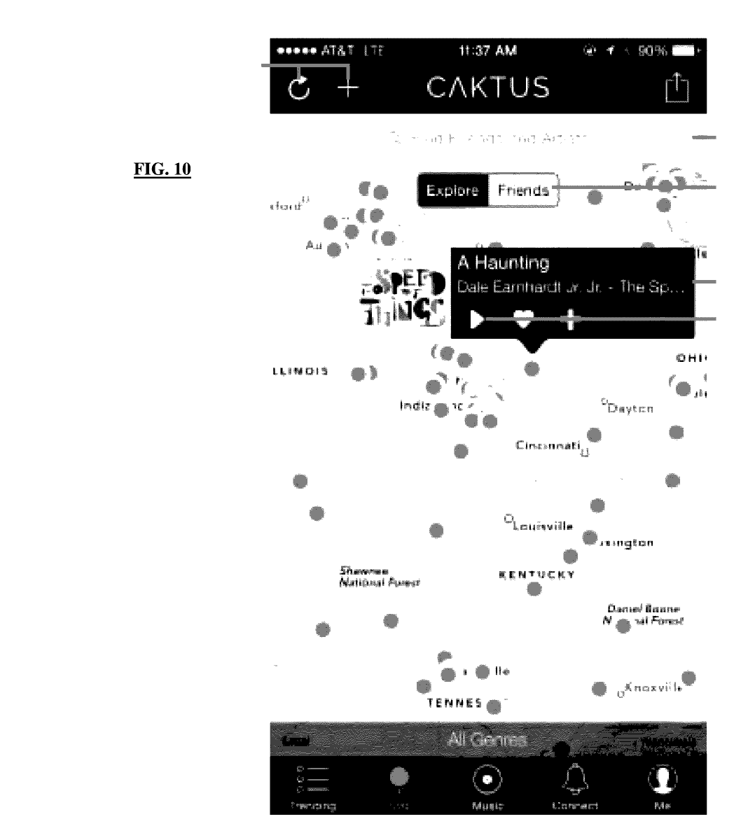

In at least one embodiment of the present disclosure, nearby plays of songs, artists, and genres are displayed in step 512. The results may be displayed in an interactive map, such as, for example, as shown in FIGS. 9 and 10. The results may also be displayed in a table format.

It will be appreciated that the systems and methods disclosed herein may also include features that allow the user to share through social media platforms, the fact that he/she is considering making a purchase of the package or event. In other embodiments of the present disclosure, the sharing of purchases via social media may further drive interest in a particular artist, tour, package or even particular commerce in that others may be more inclined to make a similar purchase on these social media platforms.

In at least one embodiment of the present disclosure, the system 100 may further display the event matches, and the user's music habits on a map to graphically indicate the user's activities.

It will therefore be appreciated that the present disclosure includes systems and methods to help fan engagement by providing live event notification, thereby increasing fan satisfaction and increasing revenue for artists.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

We claim:

1. A computerized method for music artist fan engagement, the method comprising:
receiving one or more user music plays of a user at a mobile application, each of the one or more user music plays having a song name, artist name, genre, and timestamp;
inserting each of the one or more user music plays into a play database;
transmitting a user request from the mobile application, the user request indicating that the user desires to view nearby concert opportunities;
retrieving the geographic location of the user through the mobile application;
performing searches of nearby concert opportunities based at least in part on the one or more user music plays;
identifying concert opportunities in a geographic proximity to the geographic location; and
transmitting a notification to the mobile application of identified concert opportunities.

2. The method of claim 1, further comprising:
receiving a purchase request from the mobile application for an identified concert opportunity;
facilitating purchase of one or more concert tickets for the identified concert opportunity based at least in part on the purchase request.

3. The method of claim 1, wherein the user may configure the geographic proximity through the mobile application.

4. The method of claim 1, wherein the performing step may reference multiple third party databases of concert opportunities.

5. The method of claim 1, wherein the notification is a push notification to a smartphone.

6. The method of claim 1, wherein the notification is an electronic communication.

7. The method of claim 1, wherein the geographic location is based at least in part on IP geolocation.

8. The method of claim 1, wherein the geographic location is obtained from GPS of a smartphone.

9. A computerized method for music discovery, the method comprising:
receiving one or more user music plays of a user at a mobile application, each of the one or more user music plays having a song name, artist name, genre, and timestamp;
inserting each of the one or more user music plays into a play database;
transmitting a user request from the mobile application, the user request indicating that the user desires to view nearby music plays;
retrieving the geographic location of the user through the mobile application;
performing searches of nearby music plays from the play database based at least in part on the one or more user music plays;
displaying nearby music plays in the mobile application.

10. The method of claim 9, wherein the geographic location is based at least in part on IP geolocation.

11. The method of claim 9, wherein the geographic location is obtained from GPS of a smartphone.

12. The method of claim 9, wherein the nearby music plays are displayed in a map.

13. The method of claim 9, wherein the nearby music plays are displayed in a table.

14. A system for music artist fan engagement, the method comprising:
a play database;
a server, the server being configured to receive one or more user music plays of a user at a mobile application, each of the one or more user music plays having a song name, artist name, genre, and timestamp, insert each of the one or more user music plays into the play database, transmit a user request from the mobile application, the user request indicating that the user desires to view nearby concert opportunities, retrieve the geographic location of the user through the mobile application, perform searches of nearby concert opportunities based at least in part on the one or more user music plays, identify concert opportunities in a geographic proximity to the geographic location, and transmit a notification to the mobile application of identified concert opportunities.

15. The system of claim 14, wherein the server is further configured to receive a purchase request from the mobile application for an identified concert opportunity, and facilitate purchase of one or more concert tickets for the identified concert opportunity based at least in part on the purchase request.

16. The system of claim 14, wherein the user may configure the geographic proximity through the mobile application.

17. The system of claim 14, wherein the server is configured to reference multiple third party databases of concert opportunities.

18. The system of claim 14, wherein the notification is a push notification to a smartphone.

19. The system of claim 14, wherein the notification is an electronic communication.

20. The system of claim 14, wherein the geographic location is based at least in part on IP geolocation.
